(19) United States
(12) Patent Application Publication
(10) Pub. No.: US 2002/0023635 A1
(43) Pub. Date: Feb. 28, 2002

(54) Method of forming a base body for a diamond bit

(76) Inventors: Gunther Veik, Mader (AT); Achim Ruf, Feldkirch (AT); Christoph Laumen, Feldkirch (AT)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/933,969

(22) Filed: Aug. 21, 2001

(30) Foreign Application Priority Data
Aug. 25, 2000 (DE) 100 41 911.9

(51) Int. Cl. B28D 5/04

(52) U.S. Cl. 125/36; 125/40

(57) ABSTRACT

A method of forming a base body for a diamond bit having a tubular carrier body (2, 12) with a bottom (4), and a shank (1, 11) projecting from the bottom (1), with the carrier body (2, 12) and the bottom being produced by a spinning process.

### BACKGROUND OF THE INVENTION

1. Field of the Invention

The present invention relates to a method of forming a base body for a diamond bit having a tubular carrier body with a bottom, and a shank projecting from the bottom and designed to be received in a chuck or the like of an appropriate power tool.

2. Description of the Prior Art

Diamond bits are generally used for forming large-diameter bores in constructional components which are formed of hard materials such as concrete, stone, and the like. The diamond bits consist of a base body at the bore-side end surface of which, there is provided at least one diamond cutting element. The base body itself is formed of a tubular carrier body having a bottom and a shank projecting from the bottom. The shank extends in a direction opposite the boring or drilling direction.

German Publication DE 36 03 499 discloses a base body for a diamond bit formed of three separate parts, namely, a cylindrical shank, a tubular carrier body, and a bottom. The three separate parts are connected with each other by welding.

Each of the parts of the base body is produced separately which requires a substantial number of separate technological operations such as machining operations and welding operations. Therefore, the manufacturing costs of producing a base body are rather high. If the parts are produced at separate locations, storage and transportation costs are added to manufacturing costs. A further drawback of the conventional base body consists in its inexact concentricity which may result, e.g., from improper handling of the base bodies during their transportation. Further, the large-diameter carrier bodies can be subjected during their transportation to shocks acting in radial direction which results in the deviation of their cross-section from a circular cross-section.

Further, the tubular carrier body is brought into a final shape primarily by machining which insure obtaining of smooth inner and outer surfaces. However, when, e.g., the diamond cutting element, which is provided at the bore-side end surface of the carrier body, undergoes a sidewise wear, the high friction between the smooth outer surface of the tubular carrier body and the inner wall of the bore adversely affects the quality of the bore surface. A further drawback of the smooth surfaces consists in that they are not suitable for removing drillings from annular slot produced by the diamond bit.

Accordingly, an object of the present invention is to provide a cost-effective method of manufacturing of base bodies for diamond bits.

Another object of the present invention is to provide a method of manufacturing of base bodies the carrier body of which is characterized by small weight, small wall thickness, and good concentricity.

A further object of the present invention is to provide a method of manufacturing of base bodies the carrier body of which has an outer surface that provides for removal of drillings from formed circular slots.

A still further object of the invention is a base body for a diamond bit and which characterized by a sufficient rigidity so that it is not damaged during transporation.

### SUMMARY OF THE INVENTION

These and other objects of the present invention, which will become apparent hereinafter, are achieved by providing a method of forming a base body for a diamond bit and including providing a blank having a carrier body portion and a shank portion projecting from one of end surfaces of the carrier body portion, placing the blank in a spinning machine-tool, with the shank portion being secured in a main spindle of the spinning machine-tool, pressing a mandrel against another, free end surface of the carrier body portion, and forming the carrier body, together with the bottom by subjecting the carrier body portion of the blank to a spinning process; and by providing a base body the tubular carrier body of which is formed by a spinning process.

The advantage of using the spinning process consists in that it permits to produce a base body formed of the same material and in that only a small number of operation is needed for producing the base body. The latter permits to substantially reduce the manufacturing costs.

The spinning process permits to obtain tubular bodies with a very large length. Because during spinning, the material becomes strain-hardened, very small wall thicknesses can be obtained which correspond to 0.008 0.016 of the outer diameter of the carrier body. Despite its small wall thickness, the carrier body has a sufficient rigidity necessary for drilling bores. The reduced wall thickness of the carrier body results in a total reduction of weight of the base body, which is particularly important when the diamond bit is used with a hand-held power tool.

Preferably, the produced carried body has a deviation of concentricity of less than 1.3 mm. Such a small concentricity deviation can be obtained only by spinning during which the deformable material is uniformly displaced by press rollers. In addition, the bottom, which is formed as one-piece with the tubular wall of the carrier body, provides for a high radial rigidity so that the tubular carrier body does not become deformed, e.g., during transportation, as a result, e.g., of improper handling.

Because the radial extent of the cutting element, which is provided at the bore-side end of the tubular carrier body only slightly exceeds the wall thickness of the carrier body, the increasing wear of the cutting element leads to friction between the outer surface of the carrier body and the wall of the formed bore. This friction results in the heating of the entire base body and to an increased load acting on the drive motor used for driving the diamond bit. By providing a predetermined profile on the inner and/or outer tide of the tubular wall of the carrier body, the size of the surface, which contacts the surfaces of the produced circular slot can be significantly reduced. In this way the friction between the carrier body and the bore surfaces can be substantially reduced. Another advantage of providing of a shaped profile on the tubular body consists in that the profile can be formed as reinforcing ribs which further increase the rigidity of the tubular carrier body.

Another advantage of providing of a shaped profile on the tubular wall of the carrier body, preferably in form of a helix, consists in that it contributes to removal of drillings from the formed circular slot. The carrier body has a wall thickness, in the region of the profile, which corresponds at or most to 0.03 of outer diameter of the carrier body.

Because the at least one diamond cutting element, which is provided or the bore-side, free end of the carrier body, is secured thereto by soldering or welding, a correspondingly large connection area becomes necessary. A large connection area is obtained by increasing the wall thickness of the carrier body radially outwardly towards its bore-side free end. The increase of the wall thickness of the carrier body radially outwardly is effect along a predetermined portion of the entire length of the carrier body. The increase of the wall thickness can be also effected radially inwardly or both radially outwardly and inwardly. When the wall thickness of the carrier body increases only radially inwardly, the inner diameter of the tubular body naturally decreases toward the free end of the tubular body.

The wall thickness of the carrier body, at its bore-side, free end, corresponds, e.g., to 0.012-0.014 of the outer diameter of the carrier body measured in the region of the thickness increase.

In order to provide for a smooth transition region between the increased thickness section and the regular thickness section of the carrier body and which would not adversely affect the removal of drillings, the increased thickness section extends over a length corresponding to 0.04-0.14 of the entire length of the carrier body.

To provide the carrier body with a particularly high stability, the bottom of the carrier body is formed as a bell bottom. The base member is formed, preferably, of metal that can be deformed by spinning rather easily.

The novel features of the present invention, which are considered as characteristic for the invention, are set forth in the appended claims. The invention itself, however, both as to is construction and its mode of operation, together with addition advantages and objects thereof, will be best understood from the following detailed description of preferred embodiments, when read with reference to the accompanying drawings.

### BRIEF DESCRIPTION OF THE DRAWINGS

The drawings show:

FIG. 1 a front elevational view of a blank from which a base body according to the present invention for a diamond bit is formed;

FIG. 2 a front elevational view of the blank shown in FIG. 1 together with a pressing roller mandrel;

FIG. 3 an elevational, partially cross-sectional view illustrating formation of a tubular carrier body of the blank shown in FIG. 1 with pressing rollers;

FIG. 4 an elevational view illustrating machining of the shank and a bore-side end of the carrier body; and

FIG. 5 a partially cross-sectional, front elevational view of another embodiment of a base body according to the present invention the carrier body of which is provided with a predetermined profile.

### DETAILED DESCRIPTION OF THE PREFERRED EMBODIMENTS

FIG. 1 shows a machined, cast or forged blank with non-treated shank and a carrier body portion 2. With a main spindle of a spinning machine-tool (not shown), the blank is brought into contact with a mandrel 3. As shown in FIG. 2 the mandrel 3 has, e.g., a cylindrical outer profile. The mandrel 3 is pressed against an end surface of the carrier body 2 which faces in the bore direction, i.e., in a direction in which the end surface would have faced if positioned in front of a component in which a bore is to be formed.

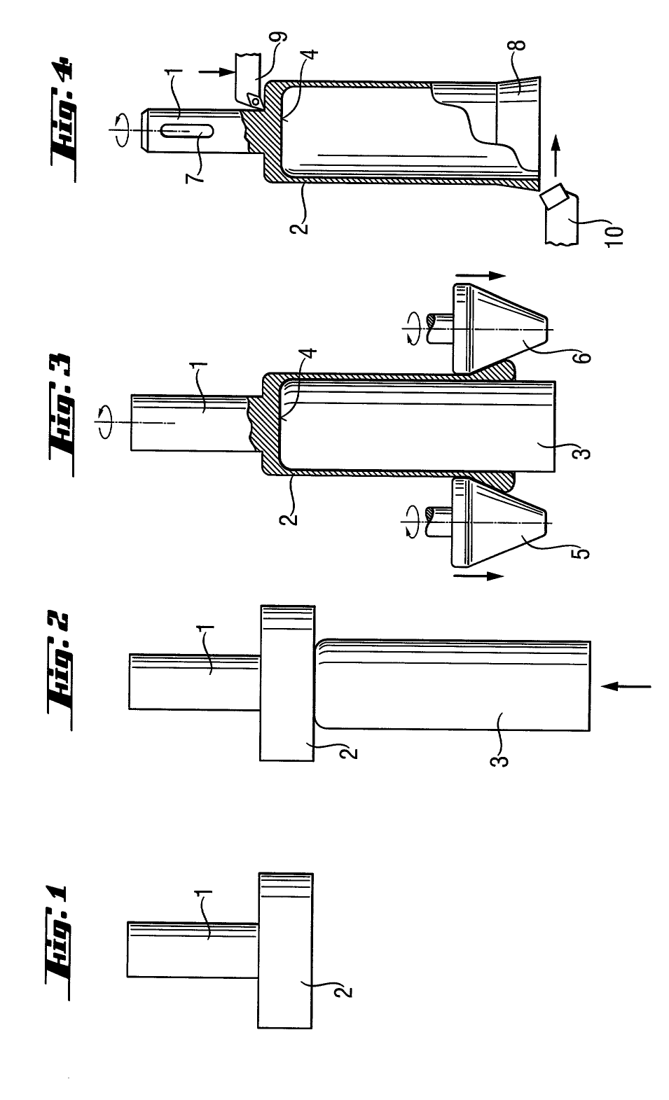

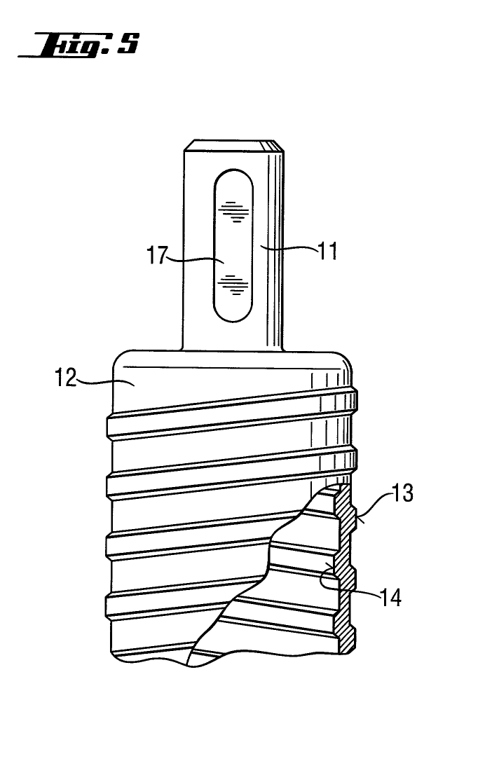

The shank is secured in the spinning machine-tool against displacement in the axial direction and is rotated by the main spindle of the spinning machine-tool. The direction of rotation of the blank is indicated with an arrow in FIG. 3. Two pressing rollers 6 and 6 have a conical shape, tapering in the bore direction, as is also shown in FIG. 3. The pressing rollers 5 and 6 are displaced axially along the mandrel 3 as shown by straight arrows, while simultaneously being rotated in a direction opposite the rotational direction of the blank. As a result of pressure applied by the rollers 5 and 6, the material of the carrier body 2 is plastically deformed while being simultaneously partially displaced along the mandrel 3. As a result, the carrier body 2 takes a tubular shape. The predetermined movement of the rollers 5 and 6 results in that the portion of the blank, which forms the carrier body 2, is reduced to a predetermined wall thickness and is brought to a predetermined length.

Upon displacement of the rollers 5 and 6 in the bore direction, the mandrel 3 is displaced in the opposite direction. The displacement of the mandrel 3 in the direction opposite the bore direction causes a portion of a material, of which the carrier body 2 is formed, to displace sidewise forming a bottom 4 the thickness of which exceeds the wall thickness of the tubular section of the carrier body 2. The wall thickness of the tubular section, which is formed by the spinning process, can amount to from 0.7 mm to 2.5 mm, in particular, to 1.7 mm. The tubular section has a radial run-out at most of 1.1 mm. The thickness of the bottom 4 amounts to about 10 mm. The spinning process permits to obtain tubular bodies having a length from 20 to about 500 mm.

The thickness of the wall of the tubular section of the carrier body 2 increases toward the bore-side end of the tubular section in order to provide for a reliable mounting of a diamond cutting element (not shown). The increased diameter portion or the widened portion 8 of the tubular section is obtained as a result of widening of the outer profile of the tubular section at its all, bore-side end. The length of the widened portion 8 in a direction parallel to the longitudinal extent of the tubular section corresponds to from about 0.04 to about 0.14 of the entire length of the carrier body 2. The wall thickness of the carrier body 2 at the bore-side, free end of the tubular section amounts to from about 1.5 mm to 3.5 mm. The bottom of the carrier body has a shape of a bell.

A longitudinal groove 7 in the shank 1 is machined by a cutter 9, and the free, bore-side end of the tubular section of the carrier body 2 is finished by a cutter 10, as shown in FIG. 4.

FIG. 5 shows a base body having a shank 11 and a carrier body 12. The shank 11 has a closed groove 17. The inner and outer sides of the carrier body 12 are provided with a shaped profile, e.g., of a trapezoidal thread.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A method of forming a base body for a diamond bit and including a tubular carrier body (2, 12) having a bottom (4), and a shank (1, 11) projecting from the bottom (4), the method comprising the steps of providing a blank having a carrier body portion and a shank portion projecting from one of end surfaces of the carrier body portion; placing the blank in a spinning machine-tool, with the shank portion being secured in a main spindle of the spinning machine-tool; pressing a mandrel against another, free end surface of the carrier body portion; and forming the carrier body (2, 12), together with the bottom (4) by subjecting the carrier body portion of the blank to a spinning process.

2. A method according to claim 1, wherein the spinning process comprises displacing of press rollers of the spinning machine-tool along the mandrel while rotating the press rollers in a direction opposite to a rotational direction of the blank.

3. A method according to claim 1, wherein the forming step includes forming a carrier body with a wall thickness corresponding to 0.008-0.016 of an outer diameter of the carrier body (2, 12).

4. A method according to claim 1, wherein the forming step includes forming a carrier body (2, 12) having a radial run-out of less than 1.3 mm.

5. A method according to claim 1, further comprising the steps of providing a shaped profile on at least one of outer and inner sides of the carrier body (12).

6. A method according to claim 5, wherein the shaped profile is formed as a helical profile.

7. A method according to claim 1, wherein the forming step comprises forming a carrier body a wall thickness of which increases toward a bore-side, free end of the carrier body.

8. A method according to claim 7, wherein a portion of the carrier body with an increased wall thickness has a length corresponding to 0.04-0.14 of a total length of the carrier body.

9. A base body for a diamond bit comprising a spinning-formed tubular carrier body having a bottom; and a shank projecting from the bottom in a direction opposite to a boring direction.
